(19) United States
(12) Patent Application Publication
(10) Pub. No.: US 2013/0062015 A1
(43) Pub. Date: Mar. 14, 2013

(54) WET ETCHING APPARATUS AND METHOD

(71) Applicant: Wen-da Cheng, Shenzhen (CN)

(72) Inventor: Wen-da Cheng, Shenzhen (CN)

(73) Assignee: Shenzhen China Star Optoelectronics Technology Co. Ltd., Shenzhen, Guangdong (CN)

(21) Appl. No.: 13/379,657

(22) PCT Filed: Sep. 20, 2011
(86) PCT No.: PCT/CN11/79877

§ 371 Date: Dec. 21, 2011

(30) Foreign Application Priority Data
Sep. 9, 2011 (CN) 201110267109.8

(51) Int. Cl. C03C 15/00; B23Q 7/00

(52) U.S. Cl. 156/345.23; 29/559

(57) ABSTRACT

A wet etching apparatus and a wet etching method for etching a glass substrate are disclosed. The wet etching apparatus comprises a driving device, a supporting stage, a vibrating device and a substrate fixing rack. The glass substrate is fixed at the top of the substrate fixing rack and a bottom portion of the substrate fixing rack is connected with the vibrating device; the vibrating device is fixed on the supporting stage to drive the substrate fixing rack to reciprocate; and the supporting stage is disposed on the driving device and moves along with the driving device. According to the present disclosure, by controlling the vibrating device to drive the glass substrate to reciprocate in a direction where it is desired to accelerate the etching speed, the probability that the etched material interacts with the etching solution can be enhanced to increase the side etching rate.

### BACKGROUND

1. Technical Field

The present disclosure relates to the technical field of etching, and more particularly, to a wet etching apparatus and a wet etching method.

2. Description of Related Art

Liquid crystal displays (LCDs) are a kind of flat panel displays (FPDs) that display images by virtue of properties of liquid crystal materials. Compared to other displays, LCDs are thinner, lighter, require a lower drive voltage and have lower power consumption, and LCDs have become the mainstream products in the display market. A manufacturing process of conventional LCD panels generally comprises a front-end array process, a middle-end cell process and a back-end module process. The front-end array process is to produce a thin film transistor (TFT) array substrate and a color filter (CF) substrate; the middle-end cell process is to assemble the TFT substrate with the CF substrate, fill liquid crystal therebetween and dice the assembly into individual panels of specified sizes; and the back-end module process is to assemble the panels with backlight modules, panel driving circuits, outer frames and the like.

The array process includes depositing a metallic layer on a glass substrate and etching the metallic layer into conductors through wet etching. The wet etching technologies generally present front-etching properties and side-etching properties, and rates of front-etching and side-etching determine a side curvature of conductors formed through the etching process. The side curvature refers to an angle included between a side surface of a conductor and the glass substrate; and the smaller the angle, the greater the side curvature. The side curvature of the conductor has an influence on the coverage rate of a film formed in the next film-coating process. The conductor is generally required to have a large side curvature after being etched so that a desirable coverage rate will be obtained in the next film-coating process; i.e., a small angle included between the side surface of the conductor and the glass substrate will result in a desirable coverage rate obtained in the next film-coating process.

After an etching solution is sprayed onto the glass substrate, the metallic layer deposited on the glass substrate is etched by the etching solution. However, because the etching solution provides an isotropic etching effect (i.e., the etching rates at which the metallic layer in contact with the etching solution is etched by the etching solution are substantially the same in all directions), so it is impossible to achieve different etching rates at different locations of the metallic layer, which makes it impossible to increase the side curvature of the conductor after being etched.

### BRIEF SUMMARY OF THE DISCLOSURE

A primary objective of the present disclosure is to provide a wet etching apparatus for etching a glass substrate, which can increase the side curvature of conductors after being etched.

The present disclosure provides a wet etching apparatus for etching a glass substrate, which comprises a driving device, a supporting stage, a vibrating device and a substrate fixing rack,

the substrate fixing rack is connected with the vibrating device;

the vibrating device is fixed on the supporting stage to drive the substrate fixing rack to reciprocate; and

the supporting stage is disposed on the driving device and moves along with the driving device.

Preferably, the vibrating device is a linear motor or a screw motor.

Preferably, the vibrating device comprises an electromagnetic (EM) device connected to the substrate fixing rack, and the EM device is magnetized or demagnetized under the control of an external circuit to drive the substrate fixing rack to move towards or away from the EM device.

Preferably, there are a plurality of vibrating devices spaced apart from each other on the supporting stage.

Preferably, the substrate fixing rack comprises a link and a fixing portion, the link is pivoted to a rotary shaft of the vibrating device, and the fixing portion is connected to the link.

Preferably, the fixing portion is a sucking disc or a clip.

Preferably, the supporting stage is further provided with an air-floating device or roll balls thereon.

Preferably, the driving device is a roller or a driving belt.

The present disclosure further provides a wet etching method, comprising the following steps of:

fixing a glass substrate on a substrate fixing rack;

controlling a driving device to move so as to drive a supporting stage disposed thereon to move together; and

controlling the driving device to operate so as to drive the substrate fixing rack fixed on the supporting stage to reciprocate.

Preferably, the wet etching method further comprises the following step while controlling the driving device to operate:

activating an air-floating device.

According to the present disclosure, by controlling the vibrating device to drive the glass substrate to reciprocate in a direction where it is desired to accelerate the etching speed, the probability that the etched material interacts with the etching solution can be enhanced to increase the side etching rate. Thereby, the side curvature of conductors on the glass substrate after being etched can be increased, thus improving the coverage rate of the film formed in the next film-coating process and reducing occurrence of abnormal film sections coated on the glass substrate.

### BRIEF DESCRIPTION OF THE DRAWINGS

FIG. 1 is a schematic structural view of an embodiment of a wet etching apparatus according to the present disclosure;

FIG. 2 is a schematic structural top view of a glass substrate shown in FIG. 1;

FIG. 3 is a schematic structural view of another embodiment of a wet etching apparatus according to the present disclosure; and

FIG. 4 is a schematic flowchart diagram of an embodiment of a wet etching method according to the present disclosure.

Hereinafter, implementations, functional features and advantages of the present disclosure will be further described with reference to embodiments thereof and the attached drawings.

### DETAILED DESCRIPTION

Hereinafter, the technical solutions of the present disclosure will be detailed with reference to the attached drawings and embodiments thereof. It shall be appreciated that, the embodiments described herein are only intended to illustrate but not to limit the present disclosure.

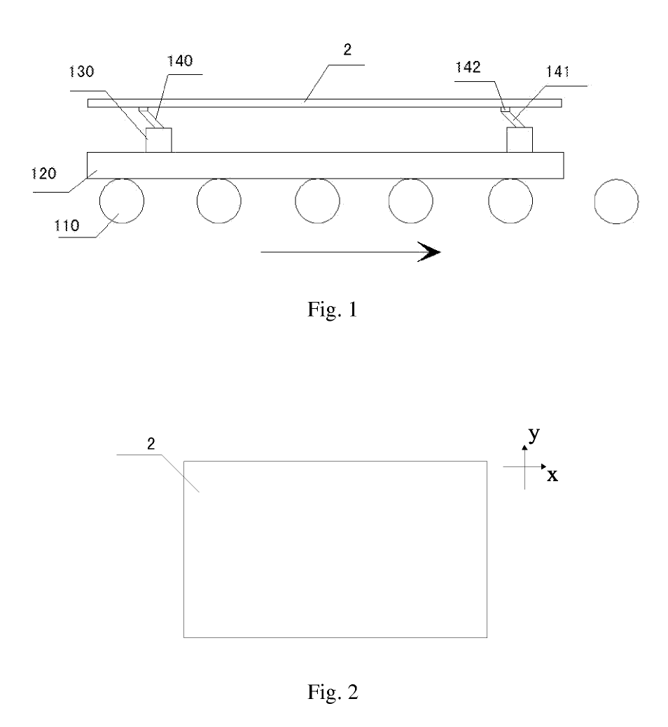

Referring to FIG. 1, a wet etching apparatus of the present disclosure comprises a driving device, a supporting stage 120, a vibrating device 130 and a substrate fixing rack 140. A glass substrate 2 is fixed at the top of the substrate fixing rack 140, and a bottom portion of the substrate fixing rack 140 is connected to the vibrating device 130. The vibrating device 130 is fixed on the supporting stage 120 to drive the substrate fixing rack 140 to reciprocate. In this embodiment, the driving device is a plurality of rollers 110, and the supporting stage 120 is disposed on the rollers 110 so as to move as the rollers 110 rotate. Of course, in other embodiments, the driving device may also be a driving belt that drives the supporting stage 120 to move.

While the supporting stage 120 is driven by the rollers 110 to move in a direction indicated by the arrow in FIG. 1, the vibrating device 130 drives the substrate fixing rack 140 to reciprocate so as to drive the glass substrate 2 to reciprocate within a horizontal plane with respect to the supporting stage 120. The reciprocating direction is the same as a direction where it is desired to accelerate the etching speed of the glass substrate 2. As shown in FIG. 2, if the direction where it is desired to accelerate the etching speed of the glass substrate 2 is the x direction, then the vibrating device 130 drives the glass substrate 2 to reciprocate in the horizontal plane along the x direction; and if the direction where it is desired to accelerate the etching speed of the glass substrate 2 is the y direction, then the vibrating device 130 drives the glass substrate 2 to reciprocate in the horizontal plane along the y direction. Of course, the direction where it is desired to accelerate the etching speed of the glass substrate 2 may also be other directions, in which case the vibrating device 130 drives the glass substrate 2 to reciprocate within the horizontal plane along the corresponding directions.

According to the present disclosure, by controlling the vibrating device 130 to drive the glass substrate 2 to reciprocate in a direction where it is desired to accelerate the etching speed, the probability that the etched material interacts with the etching solution can be enhanced to increase the side etching rate. Thereby, the side curvature of conductors on the glass substrate 2 after being etched can be increased, thus improving the coverage rate of the film formed in the next film-coating process and reducing occurrence of abnormal film sections coated on the glass substrate 2.

The vibrating device 130 may comprise a motor provided with a rotary shaft (not shown). The substrate fixing rack 140 comprises a link 141 and a fixing portion 142. The link 141 is pivoted to the rotary shaft; and one end of the fixing portion 142 is connected to the link 141 and the other end of the fixing portion 142 is used to fix the glass substrate 2. Through rotation of the motor, the substrate fixing rack 140 can be driven to reciprocate so that the glass substrate 2 reciprocates along with the substrate fixing rack 140. The motor may be either a linear motor or a screw motor. The fixing portion 142 may be a sucking disc adapted to support and fix the glass substrate 2, or a clip adapted to fix the glass substrate 2 at sides of the glass substrate 2.

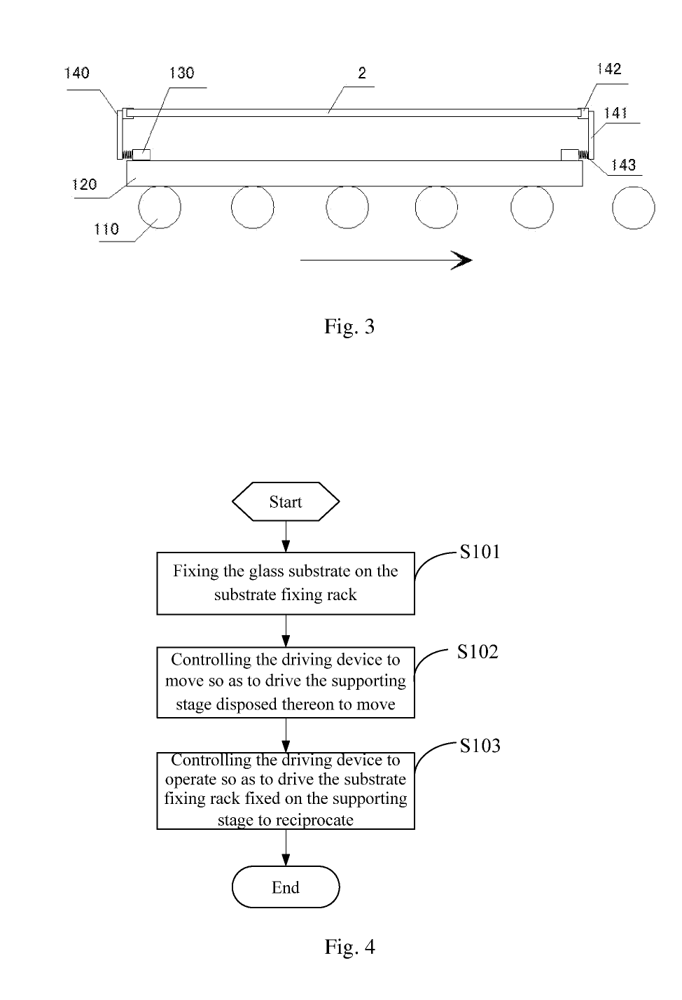

As shown in FIG. 3, the vibrating device 130 may also comprise an electromagnetic (EM) device controlled by an external circuit. The EM device is connected to the link 141 via an elastic element 143. The fixing portion 142 is adapted to fix the glass substrate 2. Under the control of the external circuit, the EM device can be magnetized to drive the link 141 in such a way that the elastic element 143 is forced to move towards the EM device. Once the EM device is demagnetized under the control of the external circuit, the elastic element 143 is released to drive the link 141 to move away from the EM device. In this way, the glass substrate 2 can reciprocate under the control of the external circuit.

There may be only one vibrating device 130 that is disposed at a center of the supporting stage 120. Alternatively, there may also be two vibrating devices 130 that are disposed at two opposite ends of the supporting stage 120. Or alternatively, there may be four vibrating devices 130, two of which are disposed at two opposite corners of one end of the supporting stage and the other two are disposed at two opposite corners of the other end of the supporting stage. Of course, in order to better control the reciprocating movement of the glass substrate 2, it is also possible that a plurality of vibrating devices 130 is disposed at different positions. For example, there are a plurality of vibrating devices disposed uniformly at two opposite ends of the supporting stage 120.

The supporting stage 120 may also be provided with an air-floating device (not shown) thereon. The air-floating device is disposed on the supporting stage 120 to blow an air flow towards the glass substrate 2 in order to reduce the resistance to motion of the glass substrate 2; additionally, in case of a large-size glass substrate, the air flow from the air-floating device can support the glass substrate to prevent sagging of the glass substrate at a center thereof. Of course, in other embodiments, a plurality of roll balls may be disposed on the supporting stage 120 with the glass substrate 2 being disposed on the roll balls, which can also support the glass substrate 2 and reducing the resistance to motion of the glass substrate 2.

FIG. 4 is a schematic flowchart diagram of an embodiment of a wet etching method according to the present disclosure.

Referring to FIG. 4, the wet etching method of the present disclosure comprises the following steps.

Step S101: fixing the glass substrate on the substrate fixing rack. In this step, the glass substrate 2 is fixed on the substrate fixing rack 140 by the fixing portion 142.

Step S102: controlling the driving device 110 to move so as to drive the supporting stage 120 disposed thereon to move together.

The driving device 110 is controlled in such a way that the supporting stage 120 disposed thereon moves along with the movement of the driving device 110.

Step S103: controlling the driving device 130 to operate so as to drive the substrate fixing rack fixed on the supporting stage 120 to reciprocate.

The method further comprises the following step when the step S103 is being executed: activating an air-floating device. The air-floating device is disposed on the supporting stage 120 and, while the vibrating device 130 drives the substrate fixing rack to reciprocate, is activated to support the glass substrate 2 and reduce the resistance to motion of the glass substrate 2.

According to the present disclosure, by controlling the vibrating device 130 to drive the glass substrate 2 to reciprocate in a direction where it is desired to accelerate the etching speed, the probability that the etched material interacts with the etching solution can be enhanced to increase the side etching rate. Thereby, the side curvature of conductors on the glass substrate 2 after being etched can be increased, thus improving the coverage rate of the film formed in the next film-coating process and reducing occurrence of abnormal films coated on the glass substrate.

What described above are only preferred embodiments of the present disclosure but are not intended to limit the scope of the present disclosure. Accordingly, any equivalent structural or process flow modifications that are made on basis of the specification and the attached drawings or any direct or indirect applications in other technical fields shall also fall within the scope of the present disclosure.

1. A wet etching apparatus, comprising a driving device, a supporting stage, a vibrating device and a substrate fixing rack,
the substrate fixing rack is connected with the vibrating device;
the vibrating device is fixed on the supporting stage to drive the substrate fixing rack to reciprocate; and
the supporting stage is disposed on the driving device and moves along with the driving device.

2. The wet etching apparatus of claim 1, wherein the vibrating device is a linear motor or a screw motor.

3. The wet etching apparatus of claim 2, wherein there are a plurality of vibrating devices disposed apart from each other on the supporting stage.

4. The wet etching apparatus of claim 2, wherein the substrate fixing rack comprises a link and a fixing portion, the link is pivoted to a rotary shaft of the vibrating device, and the fixing portion is connected to the link.

5. The wet etching apparatus of claim 4, wherein the fixing portion is a sucking disc or a clip.

6. The wet etching apparatus of claim 1, wherein the vibrating device comprises an electromagnetic (EM) device connected to the substrate fixing rack, and the EM device is magnetized or demagnetized under the control of an external circuit to drive the substrate fixing rack to move towards or away from the EM device.

7. The wet etching apparatus of claim 6, wherein there are a plurality of vibrating devices disposed apart from each other on the supporting stage.

8. The wet etching apparatus of claim 6, wherein the substrate fixing rack comprises a link and a fixing portion, the link is pivoted to a rotary shaft of the vibrating device, and the fixing portion is connected to the link.

9. The wet etching apparatus of claim 8, wherein the fixing portion is a sucking disc or a clip.

10. The wet etching apparatus of claim 1, wherein there are a plurality of vibrating devices spaced apart from each other on the supporting stage.

11. The wet etching apparatus of claim 1, wherein the substrate fixing rack comprises a link and a fixing portion, the link is pivoted to a rotary shaft of the vibrating device, and the fixing portion is connected to the link.

12. The wet etching apparatus of claim 11, wherein the fixing portion is a sucking disc or a clip.

13. The wet etching apparatus of claim 1, wherein the supporting stage is further provided with an air-floating device thereon.

14. The wet etching apparatus of claim 1, wherein the supporting stage is provided with roll balls thereon.

15. The wet etching apparatus of claim 1, wherein the driving device is a roller.

16. The wet etching apparatus of claim 1, wherein the driving device is a driving belt.

17. A wet etching method, comprising the following steps of:
fixing a glass substrate on a substrate fixing rack;
controlling a driving device to move so as to drive a supporting stage disposed thereon to move together; and
controlling the driving device to operate so as to drive the substrate fixing rack fixed on the supporting stage to reciprocate.

18. The wet etching method of claim 17, further comprising the following step while controlling the driving device to operate:
activating an air-floating device.
